(19) United States
(12) Patent Application Publication
(10) Pub. No.: US 2014/0293027 A1
(43) Pub. Date: Oct. 2, 2014

(54) 3D Stereoscopic Image Generating Method, 3D Stereoscopic Image Generating System and Non-Transitory Computer-Readable Medium that Stores 3D Stereoscopic Image Generating Program

(71) Applicant: ARCHWAY3D CO., LTD., Tokyo (JP)

(72) Inventor: Daisuke Omori, Tokyo (JP)

(73) Assignee: ARCHWAY3D CO., LTD., Tokyo (JP)

(21) Appl. No.: 14/228,518

(22) Filed: Mar. 28, 2014

(30) Foreign Application Priority Data
Mar. 28, 2013 (JP) 2013-069565

(51) Int. Cl. H04N 13/04; G02B 27/22

(52) U.S. Cl. CPC H04N 13/0468; G02B 27/2214
USPC 348/59

(57) ABSTRACT

To generate a stereoscopic image that can be enjoyed by viewers of a variety of different viewing environments, the left and right eye images are generated by inputting a viewing distance, a viewing parallax and the viewing size of the display. Decisions are then made using these inputted data about the shooting distance, shooting parallax, shooting size and image size. Two photographing devices are then positionally adjusted based on desired zoom magnification and the decided shooting distance, shooting distance and shooting subject. The left and right eye images are generated by editing the images based on the decided image size.

### CROSS-REFERENCE TO RELATED APPLICATIONS

The present application claims priority upon Japanese Patent Application No. 2013-69565 filed on Mar. 28, 2013, which is herein incorporated by reference.

### BACKGROUND

1. Technical Field

The embodiments of the present invention relate to 3D stereoscopic image generating methods, 3D stereoscopic image generating systems, and 3D stereoscopic image generating programs that generate left and right eye images to obtain a stereoscopic image of a subject.

2. Related Art

Recently, 3D images (below, it may be referred to as “stereoscopic images”) are becoming widespread as contents for movies, TV programs and the like.

In general binocular parallax is used to reproduce a stereoscopic image on a two-dimensional display such as a screen of a movie theater or a television screen. As a technique using binocular parallax, a so-called two-view stereoscopic display is well known. The basic principle of this two-view stereoscopic display is to input a right eye image to only the right eye and a left eye image to only the left eye (below, an image for the right eye is referred to as a “right eye image”, and an image for the left eye is referred to as a “left eye image”, and these combined together may be referred to as “left and right eye images”).

A stereo camera is used as a device to shoot such left and right eye images. The stereo camera includes a pair of left and right object optical systems that have shooting optical axes parallel with each other and that are placed apart in the horizontal direction, and the stereo camera records separately images from each of the left and right object optical systems (left eye image, right eye image). The recorded left and right eye images can be displayed on a display screen such as a display device. The left and right eye images with parallax that are displayed on the display screen are input selectively to the left and right eyes of the viewer, so that the viewer can view the stereoscopic image. Alternatively, the left eye image and the right eye image are displayed in parallel on the display screen and visually recognized using a method such as a parallel method or an intersecting method, so that the viewer can view the stereoscopic image. For example, in Japanese Patent Laid-open Application No. 6-095276, there is disclosed a configuration of a stereo camera that can efficiently shoot a high precision stereoscopic image, in correspondence with the distance to the subject, and also automatically record parallax information that is necessary when playing this stereoscopic image.

By the way, due to recent changes in viewing styles, there may be occasions where individual viewers view stereoscopic images on personal computers (may be referred to as “PC” below) and smartphones. Conventional stereoscopic images however, are generated assuming that unspecified (an indefinite number of) viewers will see the stereoscopic images. In other words, generally a distance between a display section that displays the left and right eye images (A display screen. A screen of a movie theater or a display of a PC, and the like.) and the viewer and the size of the display screen differ according to the viewing environment. On the other hand, conventional stereoscopic images are not generated considering such viewing environments. Therefore, in a case that a certain stereoscopic image is viewed, there is a possibility of a problem that stereoscopic effects cannot be experienced by the viewer or that the eyes easily become tired.

### SUMMARY

An advantage of some aspects of the present invention is that it is possible to provide methods, systems, and programs to generate left and right eye images to obtain stereoscopic images suited to the viewer (for example, images that give a stereoscopic effect and images that do not make the eyes tired).

An aspect of the invention is an image generating method according to claim 1 that generates left and right eye images to obtain a stereoscopic image of a subject, by editing two images obtained by shooting the subject with two photographing devices arranged so that a part of shooting sizes overlap, the method comprising:

inputting a viewing distance corresponding to a distance from a viewer viewing the stereoscopic image to a display section that displays the left and right eye images, a viewing parallax corresponding to a distance between pupils of the viewer, and a viewing size corresponding to a size of the display section;

deciding a shooting distance corresponding to a distance between the subject and the photographing devices, based on the input viewing distance;

deciding a shooting parallax corresponding to a distance between optical axes of the two photographing devices, based on the input viewing parallax;

deciding a shooting size based on a converted value of conversion to a predetermined size from the shooting size in a case that a zoom magnification of the photographing device is 1× power, a focal length of the photographing devices, a desired zoom magnification of the photographing devices, and the decided shooting distance;

deciding a size of an image corresponding to the overlapping section by subtracting the decided shooting parallax from the decided shooting size;

adjusting positions of the two photographing devices in respect to the subject, based on the desired zoom magnification, the decided shooting distance and the decided shooting parallax and shooting the subject; and

generating the left and right eye images by editing the images of the subject obtained by shooting with each of the two photographing devices, based on the decided image size.

Another aspect of the invention is the image generating method according to claim 2, the method according to claim 1, wherein the shooting parallax is decided to be a same value as the input viewing parallax.

Another aspect of the invention is the image generating method according to claim 3, the method according to claim 1, wherein the shooting parallax is decided based on the input viewing parallax, a standard zoom magnification and the desired zoom magnification of the photographing devices.

Another aspect of the invention is the image generating method according to claim 4, the method according to claim 3, wherein

the shooting parallax is decided by the following equation,

viewing parallax÷(desired zoom magnification÷standard zoom magnification).

Another aspect of the invention is the image generating method according to claim 5, the method according to claim 3, wherein

the shooting parallax is decided by the following equation,

viewing parallax×(desired zoom magnification÷standard zoom magnification).

Another aspect of the invention is the image generating method according to claim 6, the method according to any one of claims 1 to 5, wherein

the predetermined size is an L size.

Another aspect of the invention is the image generating method according to claim 7, the method according to any one of claims 1 to 6, wherein

the shooting distance, the shooting size and the shooting parallax are adjustable in a range directly proportional to the viewing distance and the viewing parallax.

Another aspect of the invention is the image generating method according to claim 8, the method according to any one of claims 1 to 7, wherein

the viewing distance and the viewing size are in a directly proportional relationship with a viewing parallax of the viewer.

Another aspect of the invention is an image generating system according to claim 9 including two photographing devices that shoot a subject and that are arranged so that a part of shooting sizes overlap, and a processing apparatus that generates left and right eye images to obtain a stereoscopic image of the subject by editing two images obtained by shooting the subject, the system comprising a processing apparatus including:

an input section that inputs a viewing distance corresponding to a distance from a viewer viewing the stereoscopic image to a display section that displays the left and right eye images, a viewing parallax corresponding to a distance between pupils of the viewer, and a viewing size corresponding to a size of the display section;

a calculating section
that decides a shooting distance corresponding to a distance between the subject and the photographing devices, based on the input viewing distance,
that decides a shooting parallax corresponding to a distance between optical axes of the two photographing devices, based on the input viewing parallax,
that decides a shooting size based on a converted value of conversion to a predetermined size from the shooting size, in a case that a zoom magnification of the photographing device is 1× power, a focal length of the photographing devices, a desired zoom magnification of the photographing devices, and the decided shooting distance;
that decides a size of an image corresponding to the overlapping section by subtracting the decided shooting parallax from the decided shooting size,

a driving section that adjusts positions of the two photographing devices in respect to the subject, based on the desired zoom magnification, the decided shooting distance and the decided shooting parallax, and

an image processing section that generates the left and right eye images by editing, based on the decided image size, the image of the subject obtained by shooting with each of the two photographing devices that have been adjusted in position by the driving section.

Another aspect of the invention is a non-transitory computer-readable recording medium according to claim 10 that stores an image generating program for generating left and right eye images to obtain a stereoscopic image of a subject, by editing two images obtained by shooting the subject with two photographing devices arranged so that a part of shooting sizes overlap, the program causing a computer to

input a viewing distance corresponding to a distance from a viewer viewing the stereoscopic image to a display section that displays the left and right eye images, a viewing parallax corresponding to a distance between pupils of the viewer, and a viewing size corresponding to the size of the display section,

execute a process to decide a shooting distance corresponding to a distance between the subject and the photographing devices, based on the viewing distance input by the input section and corresponding to a distance from a viewer viewing the stereoscopic image to a display section that displays the left and right eye images,

execute a process to decide a shooting parallax corresponding to a distance between optical axes of the two photographing devices, based on the viewing parallax input by the input section and corresponding to a distance between pupils of the viewer,

execute a process to decide the shooting size based on a converted value of conversion to a predetermined size from the shooting size, in a case that a zoom magnification of the photographing devices is 1× power, a focal length of the photographing devices, a desired zoom magnification of the photographing devices, and the decided shooting distance,

execute a process to decide a size of an image corresponding to the overlapping section by subtracting the decided shooting parallax from the decided shooting size,

execute a process to adjust positions of the two photographing devices in respect to the subject, based on the desired zoom magnification, the decided shooting distance and the decided shooting parallax, and

execute a process to generate the left and right eye images by editing, based on the decided image size, the image of the subject obtained by shooting after positions of the two photographing devices have been adjusted.

With the image generating method of this invention, the shooting conditions (to be described later) of the photographing devices are decided based on the viewing conditions of the viewer (to be described later). The photographing devices perform shooting based on the decided shooting conditions and obtain the left and right eye images. Therefore, it becomes possible to provide the left and right eye images to obtain stereoscopic images suited to the viewer.

Other features of the present invention will be made clear through the present specification with reference to the accompanying drawings.

### BRIEF DESCRIPTION OF THE DRAWINGS

For a more complete understanding of the present invention and the advantages thereof, reference is now made to the following description taken in conjunction with the accompanying drawings wherein:

FIG. 1 is an overall view of a left and right eye image generating system that is common to Embodiments 1 to 3;

FIG. 2 is a drawing supplementing the description of the left and right eye image generating system comprising subparts 2A, 2B and 2C;

FIG. 3 is a flow chart showing operations of the left and right eye image generating system;

FIG. 4A is a drawing showing a photographing side of Embodiment 1;

FIG. 4B is a drawing showing a viewing side of Embodiment 1;

FIG. 5A is a drawing showing a photographing side of Embodiment 2;

FIG. 5B is a drawing showing a viewing side of Embodiment 2;

FIG. 6A is a drawing showing a photographing side of Embodiment 3; and

FIG. 6B is a drawing showing a viewing side of Embodiment 3.

### DESCRIPTION OF EXEMPLARY EMBODIMENTS

At least the following matters will become clear through the description of the present specification and the accompanying drawings.

### <Regarding Restricting Conditions on Viewer's Side and Restricting Conditions on Photographing Device Side>

In order to provide a stereoscopic image that has a stereoscopic effect and that does not tire eyes of a viewer, an appropriate approach is necessary after correctly recognizing the restricting conditions on the viewer's side and the restricting conditions on the photographing device side.

The restricting conditions on the viewer's side are viewing distance, viewing parallax, and viewing size. The viewing distance corresponds to a distance from the viewer viewing the stereoscopic image to a display screen that displays the left and right eye images (for example, a display section 34 to be described later.). The viewing parallax corresponds to a distance between pupils of the viewer. The viewing size is a size of the display screen (the display section) that displays the left and right eye images. As explained hereafter, some or the all of the viewing distance, the viewing parallax, and the viewing size are referred to as the “viewing conditions”.

Generally, in a case where the viewing distance is short (the distance from the viewer to the display screen is short) the stereoscopic effect of the stereoscopic image becomes weak (becomes closer to a two-dimensional image), and in a case where the viewing distance is long (the distance from the viewer to the display screen is long) the stereoscopic effect of the stereoscopic image becomes thick (the stereoscopic effect is emphasized). In a case where the viewing parallax is narrow the stereoscopic effect of the stereoscopic image increases in a depth direction of the display screen (the stereoscopic image expands), and in a case where the viewing parallax is wide the stereoscopic effect of the stereoscopic image decreases in the depth direction of the display screen (the image becomes closer to a two-dimensional image). Further, as a result of the stereoscopic effect increasing too much, there are cases where a permissible range in which the brain can see three-dimensionally (fusion) is exceeded. In this case, the stereoscopic image breaks down. In a case where the viewing size is large or small in respect to the shooting size (to be described later), the stereoscopic effect of the stereoscopic image is emphasized.

The restricting conditions of the photographing device side are shooting distance, shooting parallax, and shooting size. The shooting distance corresponds to a distance between a subject and a photographing device. The shooting parallax corresponds to a distance between optical axes of two photographing devices. The shooting size is a measured range in which the photographing devices can shoot the subject. Hereafter, some or all of the shooting distance, the shooting parallax, and the shooting size are referred to as “shooting conditions”.

Generally, in a case where the shooting distance is short (the distance from the photographing devices to the subject is short) the stereoscopic effect of the stereoscopic image is emphasized, and in a case where the shooting distance is long (the distance from the photographing devices to the subject is long) the stereoscopic effect of the stereoscopic image becomes weak. In a case where the shooting parallax is narrow, the stereoscopic effect of the stereoscopic image decreases in the depth direction of the display screen, and in a case where the shooting parallax is wide, the stereoscopic effect of the stereoscopic image increases in the depth direction of the display screen. In a case where the shooting size is wide or narrow in respect to the viewing size, the stereoscopic effect of the stereoscopic image is emphasized.

<Left and Right Eye Images Generating System>

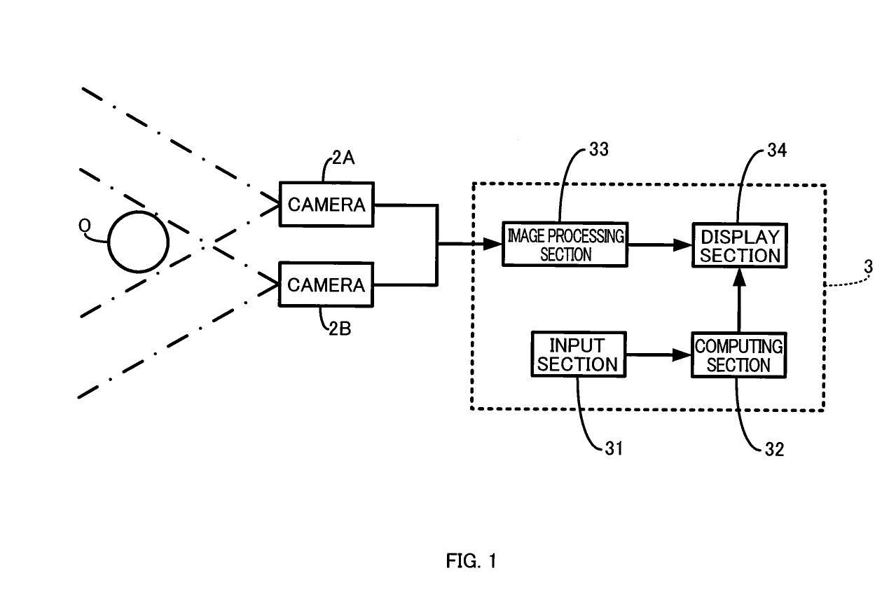

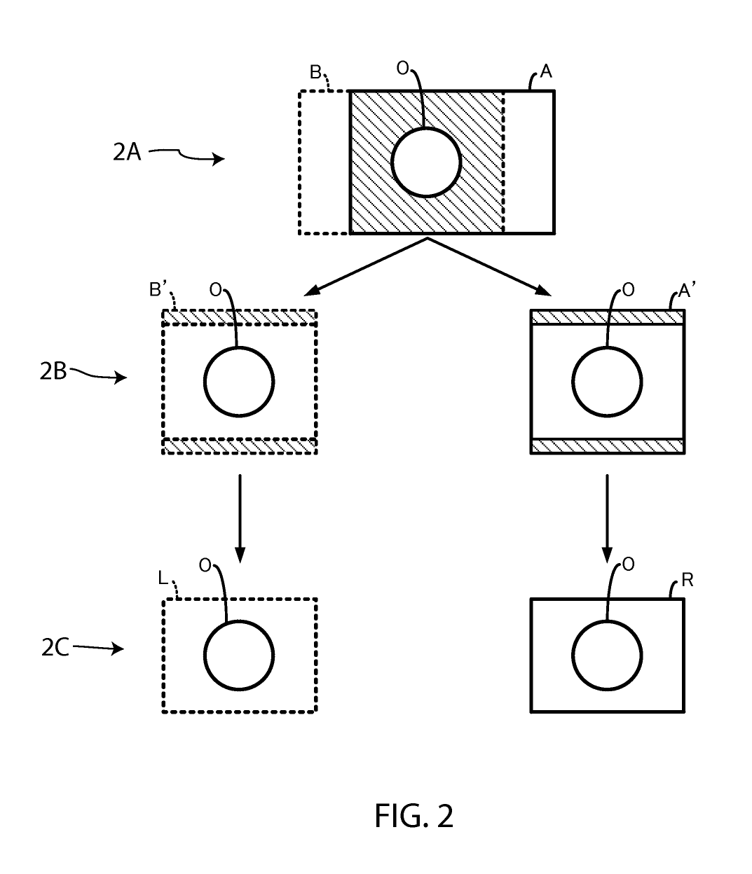

The common systems in the embodiment are described with reference to FIGS. 1 and 2. FIG. 1 is a block diagram showing a summary of a left and right eye images generating system 1 of the present embodiment. The left and right eye images generating system 1 is configured including two photographing devices (camera 2A and camera 2B) and a processing apparatus 3.

The cameras 2A and 2B are devices to shoot a subject O and to obtain an image (image data) of the subject O. The cameras 2A and 2B are arranged in parallel with a predetermined space in between so that a part of the shooting sizes overlap each other. The cameras 2A and 2B have the same capabilities (focal length, zooming range, shooting size and the like). The shooting size and the zoom magnification of the camera 2A and the camera 2B can be changed. In a case that the shooting size and the zoom magnification of one of the cameras are changed, the other camera will also be changed to have the same conditions. The image data that is obtained by shooting with the camera 2A and the camera 2B (the image data corresponding to the left and right eye images) are sent to the processing apparatus 3.

The processing apparatus 3 decides the shooting conditions of the camera 2A and the camera 2B based on the input viewing conditions. Further, the processing apparatus 3 processes the image data that has been shot with the camera 2A and the camera 2B and generates the left and right eye images.

The processing apparatus 3 can use a general PC. For example, the processing apparatus 3 is configured including an input section 31, a computing section 32, an image processing section 33, and a display section 34. The computing section 32 and the image processing section 33 are configured with a storage apparatus such as CPU, RAM, and ROM that are not shown. The storage apparatus stores a computing program that performs processing in the computing section 32 and an image processing program that performs processing in the image processing section 33. The CPU performs the programs in order to realize the functions of the computing section 32 and the image processing section 33.

The input section 31 is an interface to perform various inputs to the processing apparatus 3. The input section 31 is configured of, for example, a keyboard and a mouse. A person shooting a subject (a person shooting a subject with the photographing device) inputs the viewing distance, the viewing parallax and the viewing size via the input section 31.

The computing section 32 decides the shooting conditions for shooting the subject O with the camera 2A and the camera 2B based on the viewing conditions input via the input section 31.

Specifically, the computing section 32 decides the distance between the subject O and the cameras 2A and 2B (shooting distance), based on the input viewing distance. The computing section 32 decides the shooting parallax of the cameras 2A and 2B based on the input viewing parallax. Details on decisions of the shooting distance and the shooting parallax are shown in Embodiments 1 to 3 to be described later.

The computing section 32 decides the shooting size based on a converted value, a focal length of the camera 2A (the camera 2B), a desired zoom magnification, and a decided shooting distance. The converted value is a value of conversion to a predetermined size from the shooting size in a case that the zoom magnification of the photographing devices is 1× power. In the below description, an L size is used as the predetermined size. In this specification, the converted value in this case is referred to as “L size converted value”. Specifically, the shooting size is decided by the following equation (1).

shooting size=L size converted value÷(focal length×desired zoom magnification)×shooting distance (1)

Further, the computing section 32 subtracts the decided shooting parallax from the decided shooting size and thus decides the size of the image corresponding to an overlapping section of the shooting sizes of the cameras (below, may be referred to as “edited size”). Specifically, the edited size is decided by the below equation (2).

edited size=shooting size−shooting parallax (2)

The computing section 32 displays the computed results, for example, as numerical values on the display section 34. The person shooting the subject adjusts the positions of the cameras 2A and 2B in respect to the subject O while looking at the numerical values. The person shooting the subject then shoots the subject O by synchronizing the cameras 2A and 2B.

Note that, the left and right eye images generating system 1 can be configured to automatically perform position adjustment of the photographing devices. For example, the processing apparatus 3 is provided with a driving section that drives the photographing devices. The processing apparatus 3 drives the driving section based on the computed results of the computing section 32 so as to adjust the positions of the photographing devices. A known method can be appropriately used to drive the photographing devices.

The image processing section 33 synchronizes the image data of the cameras 2A and 2B sent via a bus (not shown) of the processing apparatus 3 and generates the left and right eye images by image processing.

Specifically, the image processing section 33 edits the image of the subject O obtained by shooting with the cameras 2A and 2B (synchronized image) based on a decided image size (edited size) and generates the left and right eye images. HIT (Horizontal Image Translation) method can be used in editing. FIG. 2 is a diagram schematically showing the image data (image) obtained with the cameras 2A and 2B. As shown in subpart 2A, the image processing section 33 cuts out an overlapping section of the image A obtained with the camera 2A and the image B obtained with the camera 2B (In other words, the edited size. A hatched section in subpart 2A.). Further, the image processing section 33 trims (the hatched section in subpart 2B) the cut out images (Image A′ and image B′. Refer to subpart 2B.). In this manner the image processing section 33 generates the left and right eye images (Right eye image R, Left eye image L. Refer to subpart 2C.).

The display section 34 is configured with any display device. For example, the display section 34 displays the computing results of the computing section 32 and left and right eye images generated with the image processing section 33. By viewing these left and right eye images, the viewer can view the stereoscopic image.

Note that, the form of the above processing apparatus 3 is one example. For example, the image processing section 33 and the display section 34 can be provided separately from the processing apparatus 3 (namely, the computing processing to decide the shooting conditions and the image processing to generate the left and right eye images can be performed on different PCs.)

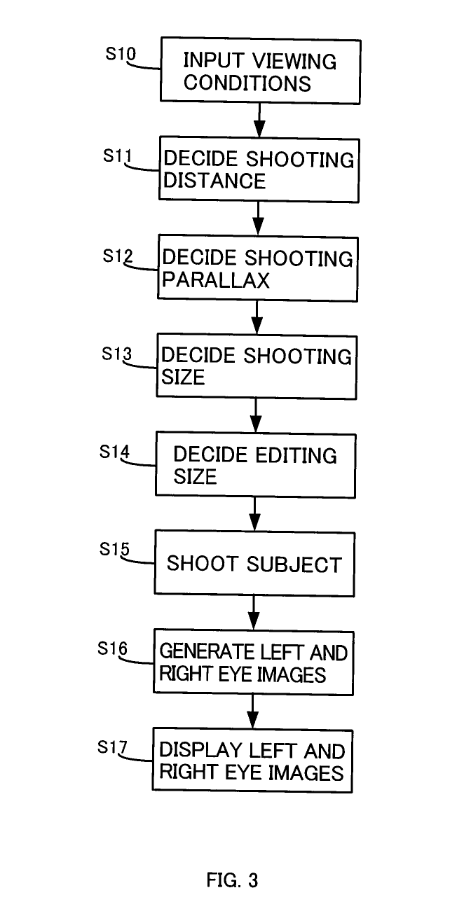

Next, the operations of the left and right eye images generating system 1 will be described with reference to FIG. 3. First, the person shooting the subject inputs the viewing distance, the viewing parallax, and the viewing size via the input section 31 (S10).

Based on the viewing distance input in S10, the computing section 32 decides the distances between the subject O and the cameras 2A and 2B (shooting distance)(S11). Based on the viewing parallax input in S10, the computing section 32 decides the shooting parallax of the cameras 2A and 2B (S12). There are numerous methods to decide the shooting parallax in accordance with the state of the stereoscopic image to be obtained and the shooting environment, as shown in Embodiments 1 to 3 to be described later. The computing section 32 decides the shooting size based on the L size converted value, the focal length of the camera 2A (the camera 2B), the desired zoom magnification, and the shooting distance decided in S11 (S13). The computing section 32 subtracts the shooting parallax decided in S12 from the shooting size decided in S13, and thus decides the edited size (S14).

Based on the desired zoom magnification, the shooting distance decided in S11, and the shooting parallax decided in S12, the person shooting the subject adjusts the positions of the cameras 2A and 2B in respect to the subject O. Then, the person shooting the subject synchronizes the cameras 2A and 2B and shoots the subject O (S15).

The image processing section 33 edits the images of the subject O (images A and B) obtained by shooting with the cameras 2A and 2B based on the edited size decided in S14, and generates the left and right eye images (left eye image L, right eye image R)(S16).

The processing apparatus 3 displays the left and right eye images generated in S14 on the display section 34 (S17). By the viewer viewing these left and right eye images, the viewer can view the stereoscopic image suited to himself/herself. Note that, due to the relationship between the edited size decided in S14 and the viewing size input in S10, the state of the stereoscopic image that the viewer views varies (details will be described in Embodiments 1 to 3).

### Embodiment 1

Embodiment 1 describes an example that provides a stereoscopic image with the same stereoscopic effect as a three-dimensional space (an actual three-dimensional space) generally seen by human eyes. Note that, in this specification, a model that fits the actual three-dimensional space is referred to as a “standard space model”. In the standard space model, the stereoscopic image progressively becomes smaller inversely proportionally to the distance to the display section 34 (display screen) that displays the left and right eye images. Namely, “perspectivism” is illustrated in the figure.

In this embodiment, an L size converted value is 36 cm and a focal length of the camera is 35 cm.

The viewing conditions to be input are viewing parallax 7.0 cm, viewing distance 70 cm, and viewing size 35 cm. The zoom magnification (desired zoom magnification) is set to 1.71× power.

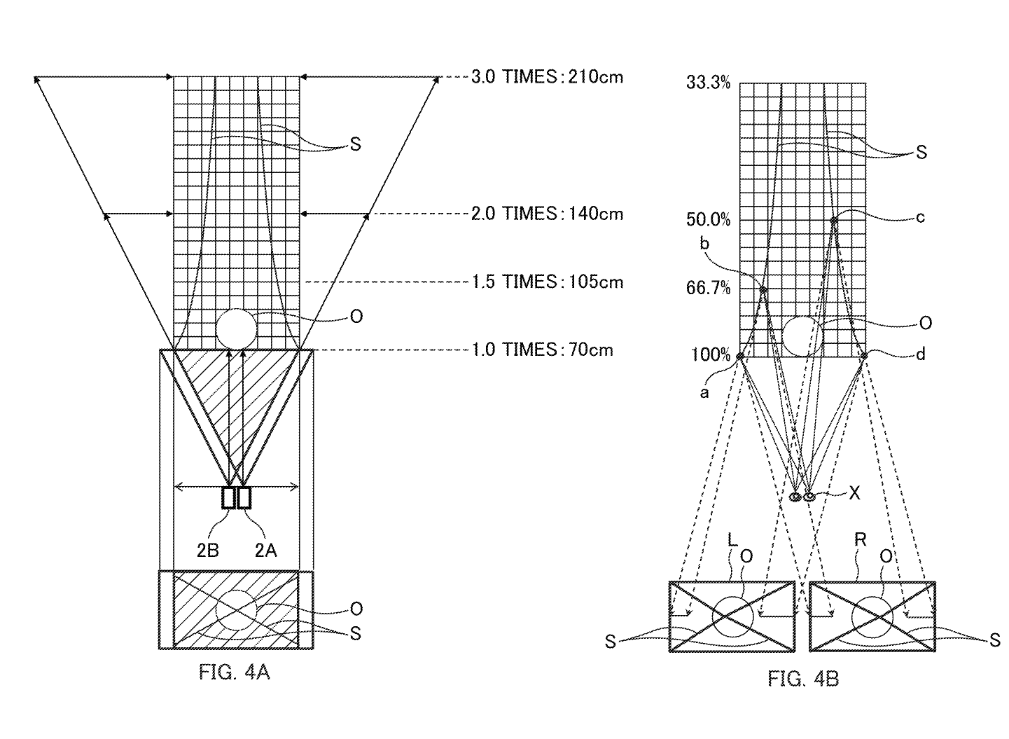

FIGS. 4A and 4B include diagrams showing a photographing side (FIG. 4A) and a viewing side (FIG. 4B) in this embodiment. In FIGS. 4A and 4B, the upper direction shows a depth direction and the lower direction shows a forward direction. FIG. 4A is a schematic diagram of a case in which cameras 2A and 2B are shooting a subject O. The numerical values shown in FIG. 4A are values showing the distances in the depth direction (for example, in a case that the depth direction is 2× power, the shooting distance becomes 140 cm.). FIG. 4B is a schematic diagram of a case in which a viewer X is viewing a stereoscopic image based on left and right eye images shot in the state in FIG. 4A. Curved lines S in FIGS. 4A and 4B show the shape of the stereoscopic image that suits the standard space model (Namely, the stereoscopic shape of the subject O in the actual three-dimensional space.).

In this embodiment, the computing section 32 decides that 70 cm, which is the same as the input viewing distance, is the shooting distance. The computing section 32 further decides that 7.0 cm, which is the same value as the viewing parallax, is the shooting parallax. The computing section 32 further decides that the shooting size is 42 cm based on equation (1). The computing section 32 decides that the edited size is 35 cm based on equation (2). Namely, in this embodiment, the viewing size and the edited size are the same values.

The person shooting the subject adjusts the shooting parallax of the cameras 2A and 2B to 7.0 cm based on the above conditions and sets the distances from the cameras 2A and 2B to the subject 0 to 70 cm. Note that, the cameras 2A and 2B are arranged in parallel to each other.

The images that are shot in this state are as shown in the lower diagram of FIG. 4A. In other words, an image A obtained with the camera 2A and an image B obtained with the camera 2B partially overlap each other (the hatched section in FIG. 4A shows an overlapped section). The image processing section 33 cuts out this overlapped section, trims each of the images, and thus generates the left and right eye images.

The processing apparatus 3 displays the left and right eye images generated in this way on the display section 34. In a case where the left and right eye images displayed in this way are viewed by the viewer X, the stereoscopic image shown by the curved lines S can be obtained (refer to FIG. 4B).

In FIG. 4B, in a case that the size of the stereoscopic image on the display screen is considered as 100%, the numerical values are values showing the ratio of the size of the stereoscopic image in a certain depth direction. This ratio can be obtained with the below equation (3).

the size of the stereoscopic image in the depth direction=viewing distance÷shooting distance (3)

For example, the size of the stereoscopic image in the depth direction with the viewing distance of 2× power becomes 50% from equation (3) (refer to FIG. 4B). The stereoscopic image that suits the standard space model in this manner is in a gradually hierarchical structure in the depth direction (the forward direction).

The lower diagram of FIG. 4B is a diagram showing how points a, b, c, and d on the curved lines S are displayed in the left and right eye images. As is clear from this diagram, a line segment connecting the points a and b and a line segment connecting the points c and d differ in length from each other with the left eye image L and the right eye image R.

By deciding that each of the values of the viewing distance and the shooting distance, the viewing parallax and the shooting parallax, and the viewing size and the edited size are the same values, the left and right eye images generating system 1 can generate left and right eye images that suit the standard space model. Thus, with this stereoscopic image based on this left and right eye images, the viewer X can experience the stereoscopic effect that is equivalent to the actual three-dimensional space. Compared with the stereoscopic image based on the left and right eye images generated without considering the viewing conditions, a stereoscopic image that does not tire the eyes can be provided.

### Embodiment 2

Embodiment 2 describes an example that emphasizes zooming. For example, in a case that the subject O is far from the photographing devices, it is necessary to shoot by increasing the zoom magnification. In this embodiment, a method of generating the left and right eye images in such a case as above is described. The sections similar to those in Embodiment 1 may be omitted of detailed descriptions.

In this embodiment, similar to Embodiment 1, the L size converted value is 36 cm and the focal length of the camera is 35 cm. Similarly, the viewing conditions to be input are viewing parallax 7.0 cm, viewing distance 70 cm, and viewing size 35 cm. On the other hand, the zoom magnification (desired zoom magnification) is set to 3.42× power.

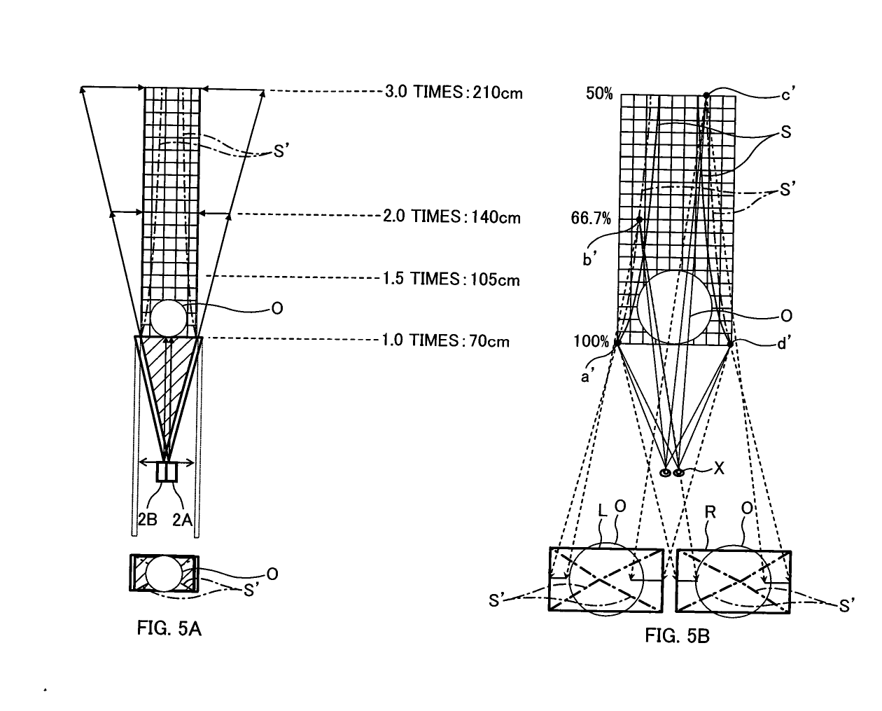

FIGS. 5A and 5B include diagrams showing a photographing side (FIG. 5A) and a viewing side (FIG. 5B) of this embodiment. In FIGS. 5A and 5B, the upper direction shows a depth direction and the lower direction shows a forward direction. FIG. 5A is a schematic diagram showing a case in which cameras 2A and 2B are shooting a subject O. FIG. 5B is a schematic diagram showing a case in which a viewer X is viewing the stereoscopic image based on the left and right eye images shot in the state in FIG. 5A. Curved lines S′ in FIGS. 5A and 5B show the stereoscopic shape of the subject O obtained by the method in this embodiment.

In this embodiment, the computing section 32 decides that 70 cm, which is the same as the input viewing distance, is the shooting distance. The computing section 32 decides that the value 3.50 cm obtained with equation (4) based on the input viewing parallax, standard zoom magnification of the camera 2A (the camera 2B), and the desired zoom magnification is the shooting parallax.

shooting parallax=viewing parallax÷(desired zoom magnification÷standard zoom magnification) (4)

Note that, the standard zoom magnification is a magnification appropriate for obtaining a stereoscopic image that fits the standard space model, and in this embodiment it is 1.71× power that has been set in Embodiment 1. The standard zoom magnification is a value that is decided by the focal length of the photographing devices and the lens diameter. Namely, with the photographing devices, the standard zoom magnification varies.

The computing section 32 decides that the shooting size is 21 cm based on equation (1). Further, the computing section 32 decides that the edited size is 17.5 cm based on equation (2). Namely, in this embodiment, the viewing size is larger than the edited size. In this case, the depth of the stereoscopic image is entirely emphasized.

The person shooting the subject adjusts the shooting parallax of the cameras 2A and 2B to 3.5 cm based on the above conditions, and sets the distances from the cameras 2A and 2B to the subject O to 70 cm. By making the shooting parallax narrower in respect to the viewing parallax in this way, shooting can be performed in a state where the emphasized depth is offset in advance.

The images that are taken in this state become that as shown in a lower diagram of FIG. 5A. In other words, an image A obtained with the camera 2A and an image B obtained with the camera 2B are partially overlapped (the hatched section in FIG. 5A shows an overlapped section). The image processing section 33 cuts out this overlapped section, trims each of the images, and generates the left and right eye images.

The processing apparatus 3 enlarges the left and right eye images generated in this way according to the viewing size and displays them on the display section 34 (In this embodiment, the processing apparatus 3 enlarges the generated left and right eye images to 2× and displays them). In a case that the left and right eye images displayed in this way are viewed by the viewer X, the stereoscopic image shown by the curved lines S′ can be obtained (refer to FIG. 5B). In this case, for example, in a hierarchy where a ratio of the size of the stereoscopic image is 50% in the depth direction in the standard space model, the stereoscopic image in this embodiment becomes a 66.7% ratio. In a hierarchy of 33.3%, the stereoscopic image in this embodiment becomes a 50% ratio. In other words, the stereoscopic image expands in the depth direction.

The lower diagram of FIG. 5B is a diagram showing how points a′, b′, c′, and d′ on the curved lines S′ are displayed with the left and right eye images. As is clear from this diagram, a line segment connecting the points a′ and b′ and a line segment connecting the points c′ and d′ differ in length from each other for the left eye image L and the right eye image R.

In this way, the left and right eye images generating system of this embodiment decides that the viewing distance and the shooting distance are the same value, decides the shooting parallax based on equation (4), and decides the edited size based on equations (1) and (2). In other words, even in a case where the left and right eye generating system 1 of this embodiment regards zooming is important, the difference in perspectivism can be solved in advance. Accordingly, with the stereoscopic image based on the obtained left and right images, the viewer X can experience the stereoscopic effect that is the same as the actual three-dimensional space. Compared with the stereoscopic image based on the left and right eye images generated without considering the viewing conditions, a stereoscopic image that does not tire the eyes can be provided.

### Embodiment 3

For example, in Embodiment 1, the stereoscopic effect of the stereoscopic image becomes close to reality. Though the focus of the viewer's eyes is at the display section 34 (display screen) on which the left and right images are displayed, the actual stereoscopic image is displayed in the forward direction or in the depth direction than the display screen. Thus, depending on the viewer, there are cases where the stereoscopic image tires the eyes. In Embodiment 3, there is described a method of generating left and right eye images to obtain stereoscopic images that are not tiring to look at and that regard stereoscopic effects as important. Note that, there are cases where detailed descriptions for sections similar to those in Embodiments 1 and 2 are omitted.

In this embodiment, similar to Embodiments 1 and 2, an L size converted value is 36 cm and a focal length of the camera is 35 cm. Similarly, the viewing conditions to be input are viewing parallax 7.0 cm, viewing distance 70 cm, and viewing size 35 cm. On the other hand, the zoom magnification (desired zoom magnification) is set to 1×.

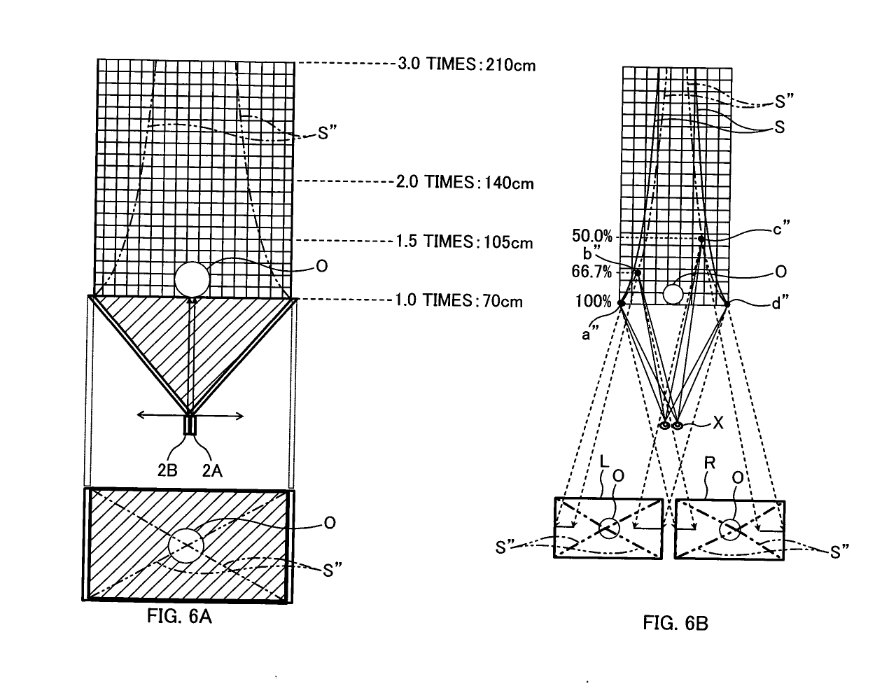

FIGS. 6A and 6B include diagrams showing a photographing side (FIG. 6A) and a viewing side (FIG. 6B) in this embodiment. In FIGS. 6A and 6B, the upper direction shows a depth direction and the lower direction shows a forward direction. FIG. 6A is a schematic diagram showing a case in which cameras 2A and 2B are shooting a subject O. FIG. 6B is a schematic diagram showing a case in which a viewer X is viewing the stereoscopic image based on the left and right eye images shot in the state in FIG. 6A. Curved lines S″ in FIGS. 6A and 6B show the stereoscopic shape of the subject O obtained with the method in this embodiment.

In this embodiment, the computing section 32 decides that 70 cm, which is the same as the input viewing distance, is the shooting distance. The computing section 32 decides the value 4.09 cm obtained from the equation (5) based on the input viewing parallax, the standard zoom magnification and the desired zoom magnification of the camera 2A (and the camera 2B) as the shooting parallax. Note that, the standard zoom magnification is 1.71× power, similar to Embodiment 2.

shooting parallax=viewing distance×(desired zoom magnification÷standard zoom magnification) (5)

The computing section 32 decides that the shooting size is 72 cm based on equation (1). Further, the computing section 32 decides that the edited size is 67.91 cm based on equation (2). Namely, in this embodiment, the viewing size is smaller than the edited size. In this case, the front (the forward direction) of the depth of the stereoscopic image is emphasized.

The person shooting the subject adjusts the shooting parallax of the cameras 2A and 2B to 4.09 cm based on the above conditions and sets the distances from the cameras 2A and 2B to the subject O to 70 cm. By making the shooting parallax in respect to the viewing parallax narrow in this way, shooting can be performed in a state in which the emphasized depth in the forward direction is offset in advance.

The images that are shot in this state become as in the lower diagram of FIG. 6A. In other words, an image A obtained with the camera 2A and an image B obtained with the camera 2B are partially overlapped (the hatched section in FIG. 6A shows an overlapped section). The image processing section 33 cuts out this overlapped section, trims each of the images, and thus generates the left and right eye images.

The processing apparatus 3 reduces the left and right eye images generated in this way in accordance with the viewing size and displays them on the display section 34 (In this embodiment, the processing apparatus 3 reduces the generated left and right eye images to approximately ½× power and displays them). In a case where the left and right eye images displayed in this way are viewed by the viewer X, the stereoscopic image shown by the curved lines S″ can be obtained (refer to FIG. 6B). In this case, for example, in a hierarchy where the size of the stereoscopic image in the depth direction in the standard space model is approximately 65%, the stereoscopic image in this embodiment becomes a 50% ratio, and in the approximately 80% hierarchy, the stereoscopic image of this embodiment becomes a 66.7% ratio. In other words, compared to the stereoscopic image in accordance with the standard space model, the stereoscopic image in this embodiment is emphasized in the forward side, and the stereoscopic effect in the depth direction is lost. The viewer X who is actually viewing the stereoscopic image however, acknowledges that the stereoscopic image is not tiring to view and is not awkward to view.

The lower diagram of FIG. 6B is a diagram showing how points a″, b″, c″, and d″ on the curved lines S″ are displayed in the left and right eye images. As is clear from this diagram, a line segment connecting the points a″ and b″ and a line segment connecting the points c″ and d″ differ in length from each other with the left eye image L and the right eye image R.

In this way, the left and right eye images generating system in this embodiment decides that the viewing distance and the shooting distance are the same value, decides the shooting parallax based on equation (5), and decides the edited size based on equations (1) and (2). In other words, the left and right eye images generating system 1 in this embodiment makes the viewing size smaller than the edited size and thus decreases the deviation in width of the left and right eye images. Further, the left and right eye images generating system 1 in this embodiment narrows the shooting parallax, thus offsets the emphasized forward depth, and further decreases the deviation in width of the left and right eye images. In this way, by decreasing the deviation in width of the left and right eye images by two levels, with the obtained stereoscopic image, the viewer X can sense a stereoscopic effect that is the same as the actual three-dimensional space. Further, in a case that Embodiment 1 and Embodiment 2 are compared, an image that is less tiring to view can be provided.

<Other Points>

In the above embodiment, for example, the shooting distance and the viewing distance are decided as the same value, but decision of the shooting conditions is not limited to the above. In other words, the shooting distance, shooting size, and shooting parallax are in a directly proportional relationship in respect to the viewing distance and the viewing parallax. For example, the computing section 32 can decide that in respect to the input viewing distance 70 cm, the shooting distance is 35 cm or 140 cm. In this case, the computing section 32 makes a decision so that the shooting size and shooting parallax are also in a directly proportional relationship. In other words, the computing section 32 can adjust the shooting conditions in respect to the viewing conditions in a range in a directly proportional relationship.

The viewing distance and the size of the display section 34 that displays the left and right eye images (viewing size) are in a directly proportional relationship with the viewer's viewing parallax. In other words, for example, in a case where a viewer Y with a viewing parallax of 5.5 cm sees the left and right eye images generated based on the viewing conditions suited for the viewer X with the viewing parallax 7.0 cm, the viewing size 35 cm, and the viewing distance 70 cm, by viewing with the viewing conditions of the viewing distance 55 cm and the viewing size 27.5 cm, a stereoscopic image that is the same for the viewer X can be viewed. In other words, the left and right eye images generated based on the viewing conditions in the above embodiment also functions as a versatile image (a versatile stereoscopic image) by readjusting the viewing conditions on the viewer's side.

Further, based on the input viewing size, the edited size can also be adjusted. For example, as in Embodiment 3, in a case where the depth of the stereoscopic image is to be emphasized at the front side (forward direction), the edited size needs to be made larger than the viewing size. Thus, the person shooting the subject sets, for example, the shooting size and the shooting parallax in equation (2) so that the edited size becomes larger than the viewing size. The computing section 32 executes the computing processing based on the set value and decides the edited size. In this case, it becomes possible to obtain a desired stereoscopic image.

What is claimed is:

1. An image generating method that generates left and right eye images to obtain a stereoscopic image of a subject, by editing two images obtained by shooting the subject with two photographing devices arranged so that a part of shooting sizes overlap, the method comprising:
inputting a viewing distance corresponding to a distance from a viewer viewing the stereoscopic image to a display section that displays the left and right eye images, a viewing parallax corresponding to a distance between pupils of the viewer, and a viewing size corresponding to a size of the display section;
deciding a shooting distance corresponding to a distance between the subject and the photographing devices, based on the input viewing distance;
deciding a shooting parallax corresponding to a distance between optical axes of the two photographing devices, based on the input viewing parallax;
deciding a shooting size based on a converted value of conversion to a predetermined size from the shooting size in a case that a zoom magnification of the photographing device is 1× power, a focal length of the photographing devices, a desired zoom magnification of the photographing devices, and the decided shooting distance;
deciding a size of an image corresponding to the overlapping section by subtracting the decided shooting parallax from the decided shooting size;
adjusting positions of the two photographing devices in respect to the subject, based on the desired zoom magnification, the decided shooting distance and the decided shooting parallax and shooting the subject; and
generating the left and right eye images by editing the images of the subject obtained by shooting with each of the two photographing devices, based on the decided image size.

2. The image generating method according to claim 1, wherein
the shooting parallax is decided to be a same value as the input viewing parallax.

3. The image generating method according to claim 1, wherein
the shooting parallax is decided based on the input viewing parallax, a standard zoom magnification and the desired zoom magnification of the photographing devices.

4. The image generating method according to claim 3, wherein
the shooting parallax is decided by the following equation,
viewing parallax÷(desired zoom magnification÷standard zoom magnification).

5. The image generating method according to claim 3, wherein
the shooting parallax is decided by the following equation,
viewing parallax×(desired zoom magnification÷standard zoom magnification).

6. The image generating method according to claim 1, wherein
the predetermined size is an L size.

7. The image generating method according to claim 1, wherein
the shooting distance, the shooting size and the shooting parallax are adjustable in a range directly proportional to the viewing distance and the viewing parallax.

8. The image generating method according to claim 1, wherein
the viewing distance and the viewing size are in a directly proportional relationship with a viewing parallax of the viewer.

9. An image generating system including two photographing devices that shoot a subject and that are arranged so that a part of shooting sizes overlap, and a processing apparatus that generates left and right eye images to obtain a stereoscopic image of the subject by editing two images obtained by shooting the subject, the system comprising a processing apparatus including:
an input section that inputs a viewing distance corresponding to a distance from a viewer viewing the stereoscopic image to a display section that displays the left and right eye images, a viewing parallax corresponding to a distance between pupils of the viewer, and a viewing size corresponding to a size of the display section;
a calculating section
that decides a shooting distance corresponding to a distance between the subject and the photographing devices, based on the input viewing distance,
that decides a shooting parallax corresponding to a distance between optical axes of the two photographing devices, based on the input viewing parallax,
that decides a shooting size based on a converted value of conversion to a predetermined size from the shooting size in a case that a zoom magnification of the photographing device is 1× power, a focal length of the photographing devices, a desired zoom magnification of the photographing devices, and the decided shooting distance;
that decides a size of an image corresponding to the overlapping section by subtracting the decided shooting parallax from the decided shooting size,
a driving section that adjusts positions of the two photographing devices in respect to the subject, based on the desired zoom magnification, the decided shooting distance and the decided shooting parallax, and
an image processing section that generates the left and right eye images by editing, based on the decided image size, the image of the subject obtained by shooting with each of the two photographing devices that have been adjusted in position by the driving section.

10. A non-transitory computer-readable recording medium that stores an image generating program for generating left and right eye images to obtain a stereoscopic image of a subject, by editing two images obtained by shooting the subject with two photographing devices arranged so that a part of shooting sizes overlap, the program causing a computer to
input a viewing distance corresponding to a distance from a viewer viewing the stereoscopic image to a display section that displays the left and right eye images, a viewing parallax corresponding to a distance between pupils of the viewer, and a viewing size corresponding to the size of the display section,
execute a process to decide a shooting distance corresponding to a distance between the subject and the photographing devices, based on the viewing distance input by the input section and corresponding to a distance from a viewer viewing the stereoscopic image to a display section that displays the left and right eye images,
execute a process to decide a shooting parallax corresponding to a distance between optical axes of the two photographing devices, based on the viewing parallax input by the input section and corresponding to a distance between pupils of the viewer,
execute a process to decide the shooting size based on a converted value of conversion to a predetermined size from the shooting size, in a case that a zoom magnification of the photographing devices is 1× power, a focal length of the photographing devices, a desired zoom magnification of the photographing devices and the decided shooting distance,
execute a process to decide a size of an image corresponding to the overlapping section by subtracting the decided shooting parallax from the decided shooting size,
execute a process to adjust positions of the two photographing devices in respect to the subject, based on the desired zoom magnification, the decided shooting distance and the decided shooting parallax, and
execute a process to generate the left and right eye images by editing, based on the decided image size, the image of the subject obtained by shooting after positions of the two photographing devices have been adjusted.
